(19) United States
(12) Patent Application Publication
(10) Pub. No.: US 2019/0329960 A1
(43) Pub. Date: Oct. 31, 2019

(54) SYSTEM FOR CONCEALMENT OF OBJECTS OR PACKAGES

(71) Applicants: Michael Allen Kale, Cumming, GA (US); Timm Mathe Ross, Lake City, FL (US)

(72) Inventors: Michael Allen Kale, Cumming, GA (US); Timm Mathe Ross, Lake City, FL (US)

(21) Appl. No.: 16/391,380

(22) Filed: Apr. 23, 2019

Related U.S. Application Data
(60) Provisional application No. 62/664,303, filed on Apr. 30, 2018.

(51) Int. Cl. B65D 81/36; A47G 29/124; A01G 9/02

(52) U.S. Cl. CPC B65D 81/365; A01G 9/02; A47G 29/124

(57) ABSTRACT

Disclosed is a system for receiving or concealing packages or objects of all sizes safely at the doorstep. The system comprises an upper portion and a lower portion used for concealment of packages or objects at the doorstep of the user. The upper portion of the system comprises a compartment for planting similar to a planter while the lower portion has a cavity that is accessible via an opening on one facing side to allow items to be placed within, providing an aesthetically pleasant system for concealing packages or objects delivered at doorstep.

### TECHNICAL FIELD

The presently disclosed embodiments relate to the field of providing a concealment for incoming packages (or any item) at doorstep of a user. More specifically, embodiments of the present disclosure relate to a planter with open accessible cavity for the concealment of objects or packages to provide safety from theft at the time when the user is not available to receive the object or package.

### BACKGROUND

Gone are the days when postal, courier or logistic service providers used to deliver envelopes and papers to the end users at their doorstep. With growing e-commerce market, the responsibility of delivering goods and packages of various shapes and sizes are increasing day by day. Postal and logistic service companies are delivering more and more goods of all shapes and sizes to the end user's doorstep.

While delivering the objects/goods or packages to the end user's doorstep, the last mile delivery is always a challenge. Delivering the objects or packages to the designated user safely is easy if the receiving user is present at the provided address or location. However, if the receiving user is absent or not available then it creates a lot of issues related to timely delivery and safety of the packages or objects to be delivered

Hard safes with locks, or mailboxes with locks are used in many houses or offices or outdoor locations to receive the package or goods but it allows or design to receive only small packages or envelopes. Moreover, these locks or mailboxes are used only for small packages or envelopes receiving purpose without any additional benefit.

Therefore, there is a need of a system for receiving the goods or package of all sizes safely at the user doorstep or any outdoor location. Further, the multi-use of the system can also act as an added feature for such product utility category.

### SUMMARY

In accordance with teachings of the present disclosure, a system for receiving or concealing the packages or objects of all sizes safely at doorstep is disclosed.

An object of the present disclosure is to provide a system comprising an upper portion and a lower portion used for concealment of packages or objects at the doorstep of users. The upper portion of the system comprises a compartment on the top that may be used for planting purposes, similar to “a planter” while the lower portion comprises a cavity that is accessible via an opening to allow items to be placed within, without a lock and key. Further, the overall system can be of various shapes and sizes such as rectangular, cubical, cuboidal, circular and the same with a cavity under the upper portion (planting portion) to provide concealment of placed objects.

The present disclosure provides a system for placement at doorstep or at an outdoor location to allow deliveries such as objects or packages to be placed within it. From a normal view the system will appear to be a normal system having a planter at the upper portion, however, the items within it will be concealed within the lower portion and not allow such ease for theft of objects or packages or personal items out in the open. It will also allow the objects or packages or items to remain safe from inclement weather providing protection from that as well.

The present disclosure provides a system specifically designed with an opening at the lower portion to provide concealment to items placed within it. The lower portion is designed to have a cavity which is covered from all sides with a small door for placing the objects or packages. Therefore, the overall system appears as the planter in appearance, provides no apparent signs of having an opening on the lower portion. The opening on the lower portion facilitates easy placement of items in concealment, without a lock and key or allowing someone into your home when you are away. Further, the door at the lower portion of the system is additionally attached with latch-based module (such as magnetic latch module) for easy opening and closing of door for concealment of packages or objects.

According to another aspect of the present disclosure, the system comprises an upper portion and a lower portion with a door, that may be used in a home, factory, office, and so forth for concealment of deliveries such as packages or objects along with maintaining the aesthetics of the outdoor space in the form of a planter.

According to another aspect of the present disclosure, the system comprises a planter specifically designed with an opening under the compartment on top to provide concealment to items placed within it.

These and other features and advantages will become apparent from the following detailed description of illustrative embodiments thereof, which is to be read in connection with the accompanying drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates an exemplary environment where various embodiments of the present disclosed system is shown;

FIG. 2 illustrates a perspective view showing various elements of the presently disclosed system; and

FIG. 3 illustrates another perspective view of the present disclosed system with a door.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). To facilitate understanding, like reference numerals have been used, where possible, to designate like elements common to the figures.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Reference throughout this specification to “a select embodiment”, “one embodiment” or “an embodiment” means that a particular feature, structure, or characteristic described in connection with the embodiment is included in at least one embodiment of the disclosed subject matter. Thus, appearances of the phrases “a select embodiment” “in one embodiment” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

The following detailed description should be read with reference to the drawings, in which similar elements in different drawings are identified with the same reference numbers. The drawings, which are not necessarily to scale, depict illustrative embodiments and are not intended to limit the scope of the disclosure.

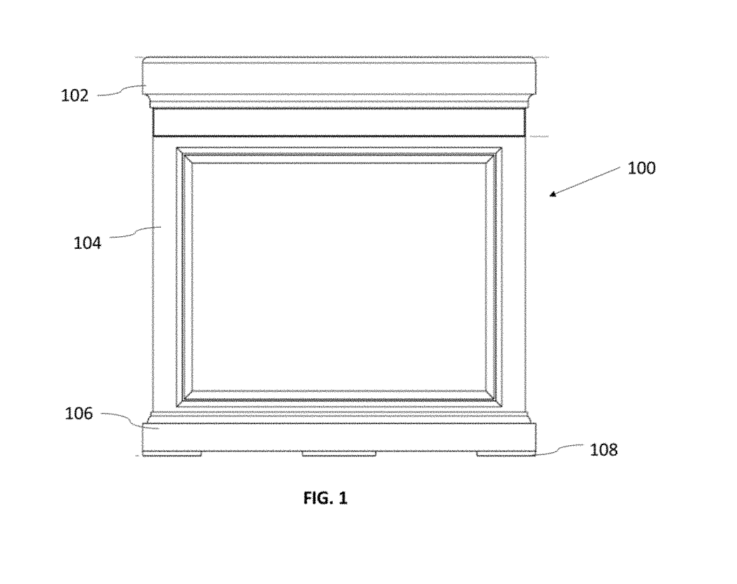

FIG. 1 illustrates an exemplary system 100, highlighting various elements of the present system. The system 100 comprises an upper portion 102 and a lower portion 104. The lower portion 104 further comprises a base 106. Further, the base 106 may optionally rest on a plurality of supporting elements 108 which if present is in direct contact with the surface on which the system is placed on.

In one of the exemplary embodiment, the system 100 has a cubical shape. Other non-limiting examples of the shape of the system can be rectangular, circular, cuboidal and the like.

In one of the exemplary embodiment, the upper portion 102 and the lower portion 104 may or may not have a common surface. In another preferred embodiment, the upper portion 102 and the lower portion 104 can be detachably attached to each other.

In one of the embodiment, the lower portion 104 comprises a base 106 to provide support to any object placed in the cavity 206 in the lower portion 104. Further, the lower portion 104 optionally comprises the supporting elements 108 to facilitate easy movement of the system 100 across the surface on which it is placed. The supporting element 108 also protects the base 106 from any wear and tear during use.

In one of the exemplary embodiment, the supporting element can be replaced by a plurality of roller systems (not shown) to facilitate easy moment of the system 100.

In one of the exemplary embodiments, the system 100 is made of wood, metal, steel, fiber, plastic, glass or any other similar material. Further, the upper portion 102 and the lower portion 104 may have different combination of material such as but not limited to the upper portion is made of glass while the lower portion have the fiber body. Preferably, the lower portion 104 is made of opaque material which aids in the concealment of object placed within the cavity 206.

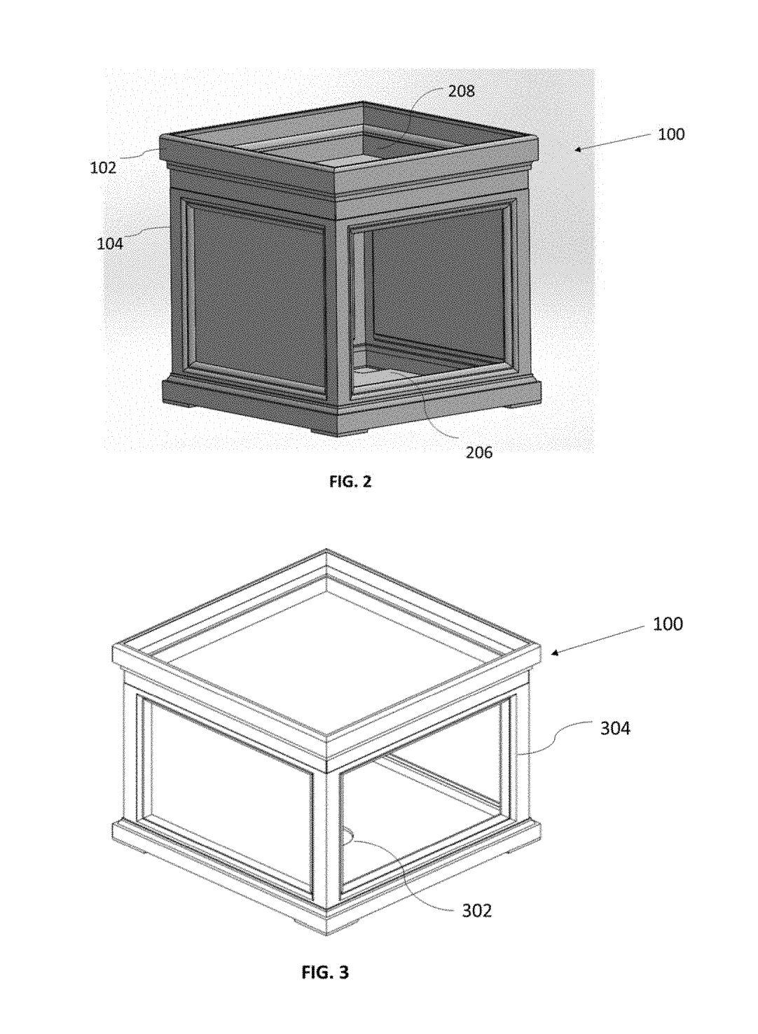

FIG. 2 illustrates the perspective view of the system 100. The upper portion 102 comprises a small compartment 208 on the top that allows the use of soil, gel bead or any other similar material conducive to growth of plant, similar to a planter. Similarly, the lower portion 104 has a cavity 206 that is accessible via an opening (shown in FIG. 3) on at-least one facing side to allow items to be placed within.

FIG. 3 illustrates the perspective view of the system 100 with a door 302. The door 302 is hinged on to one of the edges 304 present on the opening of the cavity. The opposite side of the hinge may comprise a latch system (such as magnetic latch) for closure of the door 302.

In one of the exemplary embodiment, the cavity 206 in the lower portion is used for concealment of objects or packages and provides protection from theft. The system 100 can be placed outside the doorstep to allow deliveries such as objects or packages to be placed within it. From one side it is designed to appear as a normal system having a planter at the upper portion, however, the items within it will be concealed at the lower portion and not allow such ease for theft of goods or packages or personal items out in the open. It will also allow the items to remain out of the weather providing protection from that as well.

E9OPPA

While the invention has been described in connection with what is presently considered to be the most practical and various embodiments, it is to be understood that the invention is not to be limited to the disclosed embodiments, but on the contrary, is intended to cover various modifications and equivalent arrangements.

What is claimed is:

1. A system for concealment of objects or packages comprising:
an upper portion, wherein the upper portion comprises a compartment on the top designed to be used for planting;
a lower portion, wherein the lower portion comprises a cavity for concealment of object or package place within; and
a door module hinged with the lower portion, wherein the door module is configured to allow placement of items without a lock and key.

2. The system as claimed in claim 1, wherein the door module may comprise a latch mechanism.

3. The system as claimed in claim 1, wherein the upper portion and the lower portion are detachably attached to each other.

4. The system as claimed in claim 1, wherein the system can be of various shapes and sizes.

5. The system as claimed in claim 1, provides protection from weather to the object or package placed within the cavity.

6. The system as claimed in claim 1, wherein the system provides safety from theft.

7. The system as claimed in claim 1, wherein the system can be used at doorstep or at an outdoor location.

8. The system as claimed in claim 2, wherein the system allows concealed storage of items in an aesthetic manner at the doorstep.
